(19) United States
(12) Patent Application Publication
(10) Pub. No.: US 2010/0106693 A1
(43) Pub. Date: Apr. 29, 2010

(54) IMAGE APPLIANCE SYSTEM AND METHOD

(75) Inventor: Timothy O'Donoghue, Charlotte, NC (US)

Correspondence Address: Driggs, Hogg, Daugherty & Del Zoppo, 38500 Chardon Road, Willoughby Hills, OH, 44094, US

(73) Assignee: WACHOVIA CORPORATION, Charlotte, NC (US)

(21) Appl. No.: 12/257,190

(22) Filed: Oct. 23, 2008

(51) Int. Cl. G06F 17/30

(52) U.S. Cl. 707/694; 707/E17.001

(57) ABSTRACT

Systems (and corresponding methodologies) that provide an image appliance which alleviates enterprises from custom designing each appliance for specific business processing purposes are disclosed. Enterprises and organizations can easily capture, consolidate, organize and process image files and electronic documents/content from a variety of input sources such as facsimile, electronic mail, multi-function printer devices (MFDs), desktop files, etc. without a need to custom code specific appliances.

### BACKGROUND

Appliances are devices designed to accomplish a single basic function. Oftentimes, “appliances” are called “appliance servers.” These specialized servers are designed for a specific purpose in an effort to simplify installation and maintenance. In many scenarios appliance servers bundle the hardware and software for a specific function which, when installed into an existing network, require little (if any) configuration. Traditional examples of appliance servers provide Internet sharing, FTP services, electronic mail functionality, VPN connections, etc.

Features are designed into appliances to make them easy to use. What the appliance does and does not do is easy to understand and because appliances are not custom built applications. Rather, they are easy to get and reasonably priced.

Traditional requirements-based approaches to imaging solutions tend to create more costly custom solutions with long lead times. Given the time and cost constraints of many projects, for example Business Process Off-shoring (BPO) projects within financial institutions, custom requirements-based approaches are most often not conducive to the smaller department or business unit needs. Traditional imaging systems are expensive to build and difficult to justify from a financial perspective. Thus, many business units take one or more tactical approaches such as storing documents on shared network drives or within the facsimile system. These approaches do not allow the content to be easily shared or processed. Additionally, these approaches do not provide adequate security or compliance enforcement for business and customer documents.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methodologies) that provide an image appliance which alleviates enterprises from custom designing each appliance for specific business processing purposes. Enterprises and organizations can easily capture, consolidate, organize and process image files and electronic documents/content from a variety of input sources such as facsimile, electronic mail, multi-function printer devices (MFDs), desktop files, etc.

In accordance with aspects of the innovation, each appliance is designed to perform a basic function and equipped with a set of features to make it easy to use thereby requiring minimal configuration and training. Keys to the innovation's image appliance concept is the ability to productize features and functions which alleviate overhead associated with custom work and deliver the appliance in a much shorter delivery time. These factors enable an appliance to be “ordered” by a business unit, “built” by the innovation's automated process and “shipped” to the customer with a user's manual without a need for expensive and time-intensive custom programming.

In aspects of the subject innovation, each appliance is designed to perform a basic function and is equipped with a set of features to make it easy to use. The seamless image appliance concepts package features and functions, such as input sources, content repositories, user roles and capabilities into a scenario-specific image appliance. Aspects are directed to case-type applications, organizing images and electronic documents for free-form processing and filing as well as ad-hoc document routing.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that facilitates processing of image files and other electronic data in accordance with aspects of the innovation.

FIG. 2 illustrates and example appliance system that supports basic case work in accordance with aspects of the innovation.

FIG. 3 illustrates an example flow chart of procedures that facilitate case and document management in accordance with an aspect of the innovation.

FIG. 4 illustrates an example system that facilitates free-form document management in accordance with aspects of the innovation.

FIG. 5 illustrates an example system that facilitates document routing in accordance with aspects of the innovation.

FIG. 6 illustrates an alternative example system that facilitates document routing accordance with aspects of the innovation.

FIG. 7 illustrates an exemplary New Image Appliance Order Form in accordance with aspects of the innovation.

FIG. 8 illustrates an exemplary Image Appliance Maintenance Order Form in accordance with aspects of the innovation.

FIG. 9 illustrates an alternative example block diagram of an image appliance system in accordance with aspects of the innovation.

FIG. 10 illustrates an example block diagram of a receiving component in accordance with an aspect of the innovation.

FIG. 11 illustrates an example block diagram of a case folder management component in accordance with an aspect of the innovation.

FIG. 12 illustrates an example block diagram of a case identification component in accordance with an aspect of the innovation.

FIG. 13 illustrates an example system that facilitates case folder management via a user interface in accordance with aspects of the innovation.

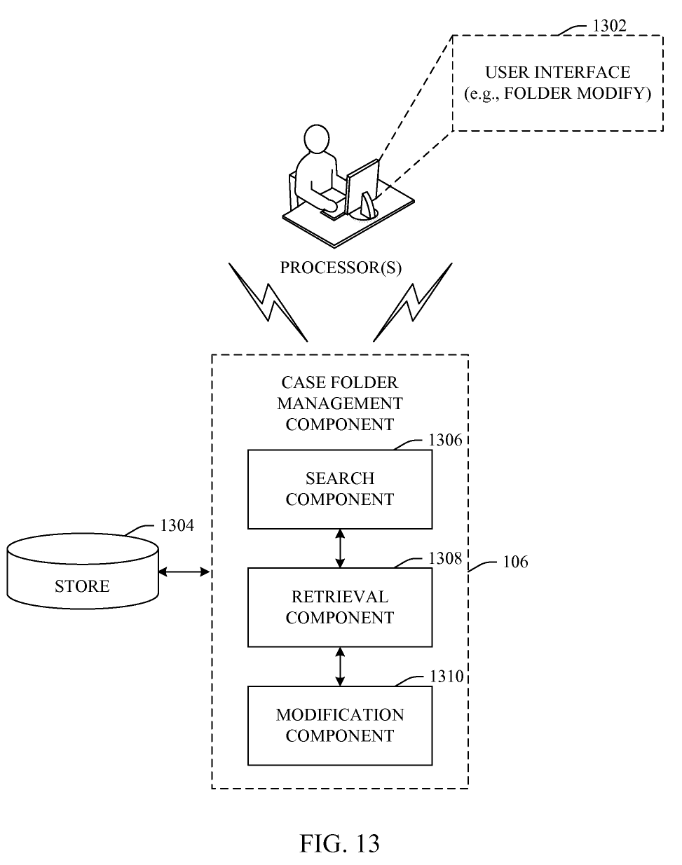

FIG. 14 illustrates a block diagram of a computer operable to execute the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “system,” and “server” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

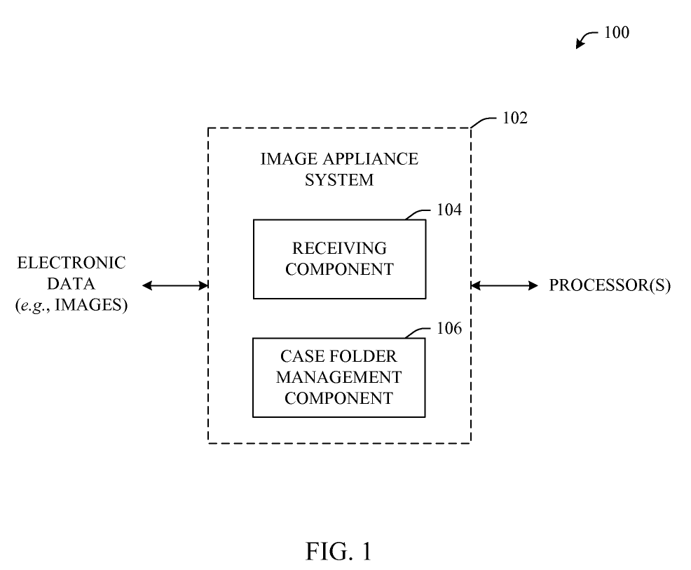

Referring initially to the drawings, FIG. 1 illustrates a system 100 that facilitates processing of image files and other electronic data. As will be described in greater detail below, aspects can capture (or otherwise receive), consolidate, organize and process data thereby enhancing efficiency of data management. Generally, the system 100 can include an image appliance system 102 that employs a receiving component 104 and a case folder management component 106. It is to be understood that, depending upon application, the case folder management component 106 can also be interchangeably referred to as a repository management component 106. Together these sub-components (104, 106) enable cost efficient and accurate management of electronic data. Effectively, electronic data, such as image data, can be received, indexed, stored, assigned, delegated, updated, etc. to and by processors within a business unit workflow.

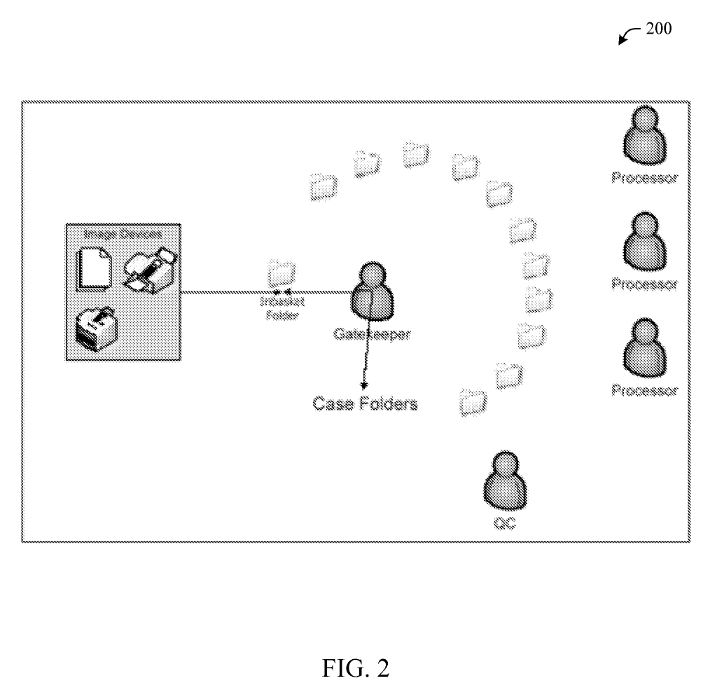

FIG. 2 illustrates a diagram of an appliance system 200 that supports basic case work in accordance with aspects of the innovation. Generally, the appliance system 200 receives electronic data, analyzes the data and stores the data into individual case files, which are also created by the system 200. Additionally, each of the individual case files can be assigned to a processor or group of processors such that workflow efficiency can be regulated and otherwise maximized.

As illustrated in FIG. 2 and described with reference thereto, the Gatekeeper role is the controlling role for the appliance. The gatekeeper works the in-basket by assigning case names to new documents. The gatekeeper can assign case folders for processing, and set status based on the business processes. The gatekeeper can have additional privileges to override checkouts, delete case documents and case folders as needed and setup status codes. It will be understood that the gatekeeper functionality can encompassed within the case folder management component 106 of FIG. 1.

Continuing with the example of FIG. 2, the processor role is responsible for the main work performed on a case. Processors search for case folders based on the dictates of the business processes. As they work a case, they view documents in the case folder, update attributes or add notes for a document, annotate images as needed and add new documents to the case folder. The researcher or QC (quality control) role is responsible for answering inquiries on cases, assisting auditors by locating required documents or providing status updates on open cases. It will be understood that the researchers have read access to the case folders and case documents.

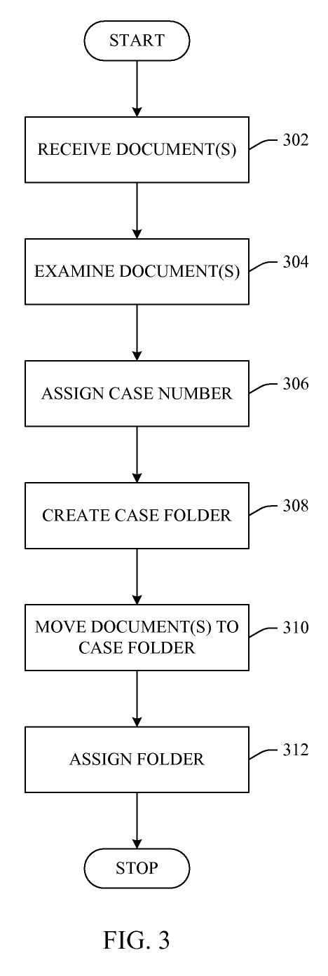

FIG. 3 illustrates a methodology of the system 200 in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, documents arrive (or are otherwise obtained and placed) in an in-basket from a variety of sources including, but not limited to, scanners, email, MFDs, desktop, etc. The documents are examined or analyzed at 304, for example by way of pattern recognition, OCR (optical character recognition), manual evaluation, etc. or combinations thereof. Additionally, a case number can be assigned and a case folder created at 306 and 308 respectively. Thereafter, at 310, documents can be moved to an appropriate case folder based upon the analysis at 304. For example, a gatekeeper as illustrated in FIG. 2 examines the document, assigns a case number which systematically creates a case folder and moves the document(s) for that case into the folder.

The folders can be assigned at 312, for example, to a processor. As illustrated in the example of FIG. 2, the gatekeeper has this ability to assign the folder to an owner, set the status of the case or use any of the other available attribute information to help route and manage the folders. In accordance with workflow procedures, the assigned processor(s) can add notes to the case folder and documents, add additional documents to the case, annotate images, change case status and owners as dictated by the business unit processes. As will be described in greater detail infra, case folders and/or documents can be retrieved by searching on any of the attributes, making it easy to locate for research purposes.

With reference again to FIG. 2, it is to be understood that the case folders hold all documents related to a case. For instance, these case folders can be maintained locally, remotely, within a centralized or otherwise distributed data store, with a cloud-based system, or combinations thereof as desired or appropriate. These alternative aspects are to be included within the scope of the innovation and claims appended hereto.

In accordance with aspects, the input devices or origination sources can include, but are not limited to facsimile, central scanning, MFDs, desktop, etc. It is to be understood and appreciated that most any input source can be used without departing from the spirit and/or scope of the innovation and claims appended hereto.

Documents can be checked out by the processor(s) for active use. Accordingly, the system 200 can monitor and indicate which processor(s) checks them out and uses them. In aspects, the case folders can be labeled with the following: Case Name, Status, Owner, Subject, etc. Similarly, documents within the case folders can be labeled with the following: Case Name, Document Description, Status, etc. In operation, the processor(s) can add notes to case folders and documents as well as annotate TIF images or other electronic data. Documents can be identified as to how they entered the system. Still further, if desired or appropriate, case folders can be linked to master case folders.

The appliance functions are grouped into the categories below. Each function indicates the role(s) that can access that function.
Working with Case Folders
Working with Case Documents
Advanced Case Folder Management

Working with Case Folders

Case folders can include all documents with the same case name. In aspects, for advanced case folder use, such as Master Case Folders, a folder can include other folders as well as unrelated (or otherwise related) documents. The following functions are provided for case folders:

A Gatekeeper, Processor or Researcher can list documents within a case folder. Once a case folder is selected, the documents within that folder will be displayed. The ability to select or sort the list of documents on any attribute value is provided. Similarly, a Gatekeeper or Processor can maintain case folder notes with regard to case folders. Gatekeepers and Processors have the ability to add freeform notes to most any case folder in accordance with proper permissions and authorizations. These notes can provide status or tracking information, quick tips on how to handle the case, URLs for further information or other notes as the business deems appropriate.

Case folders can be searched by Gatekeepers, Processors and Researchers. The ability to list all or a subset of the case folders is provided. The user has the ability to specify one or more attribute values and use wildcards to narrow the folders displayed. For example, newly created folders can be identified by searching for folders with a Status of “New.” As desired, notes associated with case folders can be displayed for viewing.

In most aspects, Gatekeepers and Processors maintain the case folder attributes. Most any of the case folder attributes can be updated. For instance, values for the Status attribute will be limited to those defined by the Gatekeeper and the system reserved status of New. Remaining values will not be validated. It is to be understood and appreciated that updating the Case Name attribute is usually not recommended as it may not affect the case name of the documents within.

Working with Case Documents

A case typically involves more than one document. As a case is worked, a range of functions are needed or employed to manage the documents and status of the case. In aspects, the Gatekeeper can cancel checkouts of case documents. Checking out a document prohibits other users from updating it until it is checked back into the system. Thus, Gatekeepers have the ability to cancel the checkout on any document. Although Gatekeepers effectively control the access to documents, in most aspects, both Gatekeepers and Processors can check-out and check-in documents. When there is a potential that other users could process a document concurrently, the system (200 or 100 of FIG. 1) provides a check-out/check-in mechanism that allows the business to synchronize access to the documents. Once a user completes work, the document is checked back into the system thereby making it available to other users for check-out and/or modification. Checked-out documents may still be viewed by other users.

As a security feature, only the Gatekeeper is authorized to delete documents. The ability to permanently delete a document prior to its defined expiration is provided. However, as a security feature, this functionality is limited to the Gatekeeper. On an as-needed or as-desired basis, documents can be exported and imported from case folders. While Gatekeepers, Processors and Researchers can export documents, only Gatekeepers and Processors can import documents into folders, unless otherwise permitted. For instance, documents from a case folder can be exported to a user-defined location. The file will be exported in its original format. Additionally, documents can be imported from a user-defined location. In accordance with the innovation, most any file type may be imported, e.g., Word, Excel, PDF. In operation, the user will enter the appropriate Case Name and the system will automatically add the document to the case folder. If no Case Name is supplied, the document will be added to the In-Basket folder. Additional document attributes may be entered. In embodiments, values for the Status attribute will be limited to those defined by the Gatekeeper and the system reserved status of New. In these instances, remaining values will not be validated.

In most scenarios, Gatekeepers and Processors maintain document attributes, notes and annotations. The system enables any of the document attributes to be updated. Values for the Status attribute will most often be limited to those defined by the Gatekeeper and the system reserved status of New. Remaining values will usually not be validated. It is to be understood that updating the Case Name attribute will automatically create a case folder with that name and place the document into the new folder. Accordingly, the document will be removed from any other case folder. Freeform notes on a document can be added. For instance, annotations or tags can be added to TIFF images. These notes and annotations are available to users who view the document.

If a document has been assigned to the wrong case folder, it can be corrected by updating the Case Name attribute. This will allow the system to automatically move it to the correct case folder. Documents can be printed through an image viewer.

The ability to search for documents is provided. In operation, a user is able to specify one or more attribute values and use wildcards to narrow the documents displayed. The resulting list of documents can be sorted on most any attribute. The number of documents returned for a search can be limited by the system defined result set limit.

The innovation provides for various viewing mechanisms. The ability to view the document in its native format is provided. In aspects, the system launches the appropriate viewer or program based on the mime type/document extension. The user has the ability to view the annotations for the document. Similarly, document history can be viewed as desired. In accordance with the innovation, documents are dated and time-stamped when added to the system, updated or otherwise modified. The system establishes version changes to the attributes of a document. It will be appreciated that this allows the business unit to track what was changed from one version to the next. Events can be viewed, e.g., via an eClient View History function. Changes between versions can be seen, e.g., via the eClient View Version Information function. The ability to display the notes associated with Case Documents is also provided.

Still further, users can view the source of a document. In other words, users have the ability to identify an input channel (e.g., facsimile, email . . . ) that introduced the document as well as channel specific information via the Capture Research Data field.

Advanced Case Folder Management

Advanced case folder management supports the use of concepts such as master case folders that allow a business unit to group individual case folders into larger cases. The ability to manually create case folders is provided for those circumstances when the automatic creation mechanism is not sufficient. This functionality may be needed to create a master case folder that will hold several individual cases. In aspects, the Gatekeeper has the ability to delete case folders. This may be needed when case names are created incorrectly.

When working with special folders such as master case folders, individual case folders or documents may be manually added or removed. Additionally, the ability to add a document to a case folder once the document has been removed from the folder is provided. It is to be understood that manual addition or removal is most often not recommended for normal case documents as these are automatically assigned to case folders based on the Case Name attribute.

Repository Design

In accordance with the repository, three item types are used:
A Case Folder item type to contain all the case folders.
A Case Document item type to contain the actual documents. Documents are placed in Case folders automatically based on the value in the Case Name attribute.
A Status Definitions item type to contain the system reserved status of New- and Gatekeeper-defined status values.

Case Folder Item Type

The Case Folder item type contains the case folders used to manage the case documents. This item type will not contain documents. With regard to general setup, the Case Folder item type contains the case folders used with the appliance. The descriptive name of the Case Folder item type will be set from the appliance order and includes the Appliance Id for easy identification. The Case Folder item type supports freeform notes. In order for the type to appear on the eClient item type list, it will be defined as a document type but access will most often be restricted to prevent the storage of documents.

The retention period for a Case Folder item type will be permanent, or otherwise as defined. The Case Folder will be eligible for deletion when the folder is empty. In operation, the Gatekeeper has the ability to manually delete individual folders prior to their expiration date.

The table below illustrates attributes for identifying and classifying case folders provided by the Case Folder item type. It is to be appreciated that validation need not be performed on any of the attributes.

| Attribute | |
|---|---|
| Name | Definition and Configuration |
| CaseName | This is the business defined Case Name. A link will be created with the |
| | CaseXpress Document item type so that the system automatically creates a |
| | case folder when a document with that case name is added or updated to |
| | the system. |
| | It is set up as required and unique. It will be defined as an index. |
| Subject | This is an optional Subject description for the case. The business can use |
| | this attribute to further identify details of the case. |
| | It is set up as optional. It will be defined as an index. |
| Status1 | This is the business defined Status for the case. |
| | It is set up as required with a default value of “New” to allow new folders |
| | to be identified. It will be defined as an index. A foreign key for this |
| | attribute will be defined to the Status item type and presented in a drop down |
| | list for selection. |
| Owner | This is the business defined Owner for the case. The business can use |
| | userids, names, departments or business units to indicate ownership. |
| | It is set up as optional. |

The following table illustrates sample access rights in accordance with aspects of the innovation. While specific access rights are illustrated, it is to be understood an appreciated that other examples exist without departing from the spirit and/or scope of the innovation and claims appended hereto.

| Role | Responsibility |
|---|---|
| Gatekeeper | Full access to create, read, update and delete Case Folders. Create and |
| | read access to the Case Folder notes. No access to the document part |
| | which prevents documents from being added to the Case Folder item type. |
| Processor | Create, read and update access to the Case Folders. Create and read access |
| | to the Case Folder notes. No access to the document part which prevents |
| | documents from being added to the Case Folder item type. |
| Researcher | Read access to the Case Folders and notes. |
| DSR | DSR Support Personnel have create, read, update and delete access for the |
| | Case Folders item type and its attributes. |
| CM Support | Content Manager Support personnel have create, read, update and delete |
| | access for the Case Folders item type and its attributes. |
| SystemInput | Consists of Trusted IDs used by the system input devices (including DSR |
| | store trusted id). Have create and update access for the Case Folders item |
| | type and its attributes. |

Case Document Item Type

The Case Document item type contains the actual documents for the cases. Documents can be added via most any of the established input channels such as indicated on the appliance order form. The Case Document item type includes documents to be stored in the appliance. In the example, the descriptive name of the Case Document item type can be set from the appliance order and includes the Appliance Id for easy identification. The Case Document item type can support annotations, notes and documents.

The retention period for the item type is set from the appliance order. All documents in the Case Document item type can have their expiration date set as the date created plus the item type retention period. In aspects, there can be no facility to extend the expiration of a document although the document can be reintroduced as a new document if needed or otherwise desired or appropriate. Additionally, the Gatekeeper can have the ability to manually delete individual documents prior to their expiration date. Once a document's expiration date is reached, the system can automatically remove the document from the system, regardless of any attribute value or presence in a Case Folder.

The Document item type can have the following attributes defined in the following order, as shown in the table below. It is to be understood that, in aspects, no validation is performed on any of the attributes.

| Attribute | Description |
|---|---|
| CaseName | This is the business defined Case Name. A link will be created with |
| | the CaseXpress Folder item type so that the system automatically |
| | creates a case folder when a document with that case name is added or |
| | updated to the system. |
| | It is set up as optional with a default value of “In-Basket”. It will be |
| | defined as an index. |
| DocDesc | This contains the business defined description for the document, e.g., |
| | New Account, Monthly Statement. |
| | It is set up as optional. |
| Status1 | This is the business defined Status for the document. |
| | It is set up as required with a default value New, which will be used |
| | by the input services to add new documents. A foreign key for this |
| | attribute will be defined to the Status item type and presented in a |
| | drop down list for selection. |
| Cap_Rsrch_Data | For documents from any of the system managed input sources, the |
| | system fills in channel specific information about the document. For |
| | details. |
| | It is set up as optional. |

In embodiments, the Gatekeeper and Processor(s) can create, read, update and delete access to documents and their attributes. Additionally, they can create and read access to the notes and annotations. Researcher has read access to the document, notes and annotations. Support personnel can usually create, read, update and delete access for document and its attributes.

### Status Definitions Item Type

In accordance with the innovation, the Status Definitions item type contains the Status values defined by the Gatekeeper. It will be used to provide values for the Status attribute dropdown. Status values will be created via the eClient Create Folder function.

The Status Definitions item type includes the status values used with the appliance. The descriptive name of the Status Definitions item type will be set from the appliance order and includes the Appliance Id for easy identification. The Status Definitions item type supports freeform notes. In order for the item type to appear on the type list, e.g., eClient item type list, it can be defined as a document type but access will be restricted to prevent the storage of documents. In most instances, the retention period for the item type will be permanent. The Gatekeeper can manually delete Status entries as needed or otherwise appropriate.

The Status Definitions item type will have the following attributes defined in the following order, as shown in the below table. No validation is performed on any of the attributes.

| Attribute | Description |
|---|---|
| Status1 | Business defined status value to appear as a dropdown |
| | selection wherever the Status attribute can be edited. The |
| | system reserved value “New” will always be available |
| | for new documents. |
| | Do to the low number of entries in this item type, no indexes |
| | will be defined. |
| Comments | A freeform comment describing the status. |

Item level security will be used for this item type so that the system reserved value of “New” can be protected. The initial “New” value can be created by the system administrator with a special ACL (access control list) which prevents a non-administrator from deleting it. The need for item level security is due to the foreign key definition, e.g., the system input services must have the New status defined or they will fail when adding document.

Here, the Gatekeeper can create, read, update and delete access to the metadata and Notes. The Gatekeeper will have no access to the base part thereby limiting entries to folders only and read access to the system reserved value of New. The Processor, Researcher and DSR Support personnel can have read access to the document (folder and notes. The CM (Content Manager) Support personnel can create, read, update and delete access to all documents and notes. It is to be understood that the IBM-brand Content Manager is employed in exemplary aspects however, other repositories can be employed without departing from the spirit and/or scope of the innovation and claims appended hereto.

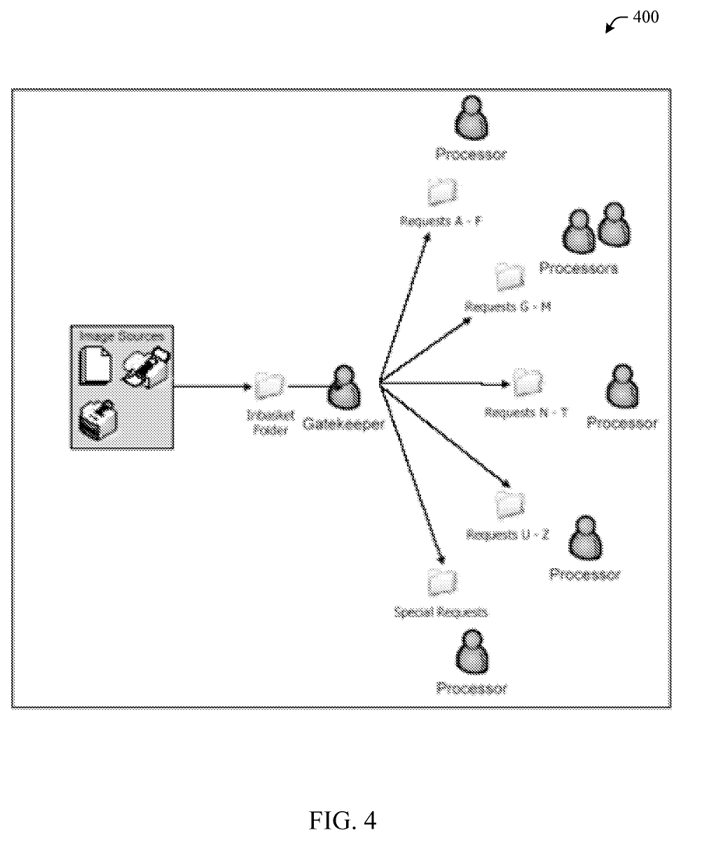

Turning now to FIG. 4, in another aspect of the innovation, a system 400 can provide a high degree of flexibility to organize documents (e.g., image documents) for processing. The innovation establishes processes that represent free-form processing steps, acts or tasks. In operation, documents are assigned to the process that is to be completed. As a given process is completed, the document can be assigned to the next process or “completed.” In this aspect, the innovation is delivered with an “In-Basket” process. The Gatekeeper creates additional processes that support a particular the business need or protocol.

The system delivers new documents to the Process item type and assigns them to the In-Basket process. As illustrated in FIG. 4, the Gatekeeper examines the document, updates any attributes as desired and assigns the document to the appropriate process. As described with the aforementioned example, this analysis or examination process can be performed manually or otherwise automated using OCR, pattern recognition or the like.

Processors work documents from their assigned process list, for example, performing any needed actions as if they were working from a paper document. They can update document's attributes as appropriate. Documents can be assigned to the next process as appropriate. To indicate the processing is complete, the document can be assigned to a ‘complete’ process or have its status set to completed. As described supra, each document can be retrieved by searching on any of the attributes, making it easy to locate for research purposes.

In accordance with the system 400, an organization or business can create and name processes based on how documents are organized for processing. The system 400 can automatically timestamp new documents and deliver them to the In-Basket process as illustrated. Similar to the example of FIG. 2, documents can be received via facsimile, eMail boxes, central scanning (DSR), MFDs, the desktop, etc. Further, documents can be checked out/in to indicate ownership while they are being worked. Documents can also be moved to other processes or marked as completed via the Status attribute. Other indicators can be added to documents, such as Subject, Status, Priority, Owner, Document Description, Process, etc. Similarly, Processors can add notes to documents and annotate images.

The Gatekeeper role is the controlling role for the appliance of FIG. 4. The Gatekeeper creates and maintains the process names and document status values as needed by the business. They also review, update and move new documents from the In-Basket to the appropriate process, import new documents, override checkouts and delete documents and folders.

The Processor is responsible for the main work performed on a document. Processors search for documents within their assigned process folders. As they work a document, they view it, update attributes or notes for a document and annotate images as needed. The researcher role is responsible for answering inquiries on documents and assisting auditors by locating required documents. In most instances, Researchers have read access to the Process Folders and Documents.

The appliance functions can be grouped into the categories below. Each function indicates the role(s) that can access that function.
Defining Processes
Working with Documents
Defining Document Statuses

Defining Processes

Gatekeepers are able to create and maintain the processes used within their business unit and Processors are able to assign documents to a process. All of the functional roles can have the ability to search for documents belonging to a certain process. As shown in FIG. 4, the In-Basket process is a reserved process used by the system input services to deliver new documents. Since this process is present and prevents failures of the input processes, it is created during appliance setup by the system administrator using an ACL that prohibits modification by Gatekeepers, Processors or Researchers.

To support the various roles, the following functions will be provided. Gatekeepers have the ability to modify the processes at most any time based on the needs (or desires) of the business unit. This includes the creation of new processes, renaming or removal of existing processes, subject to constraints as appropriate. Gatekeepers also have the ability to create and maintain freeform notes for any process. These notes can provide quick tips on how to handle documents within the process, URLs for further information or other notes as the business deems appropriate. All roles (e.g., Gatekeeper, Processor, Researcher) can be able to view the defined processes as well as notes for a process.

Working with Documents

All of the functional roles have the ability to search and display documents and their associated notes, annotations and history. Processors and Gatekeepers can update the documents as they are processed. Gatekeepers are able to perform restricted functions such as canceling checkouts and deleting documents. To support the various roles, the following functions are provided:

The Gatekeeper can cancel checkouts of documents. Checking out a document prohibits other users from updating it or its attributes until it is checked back in. The ability to cancel the checkout on any document is provided.

When there is a potential that other users could update or work a document concurrently, the system 400 provides a check-out/check-in mechanism which allows the business to synchronize access to the documents. In accordance with aspects, the Gatekeeper and Processor(s) are able to checkout and check-in documents. Once the user completes the work, the document will be checked back in. For security, the ability to permanently delete a document prior to its defined expiration is provided and limited to the Gatekeeper.

The system 400 provides for exportation and importation of documents. The ability to export documents is provided to the Gatekeeper, Processor(s) and Researcher(s). The file can be exported in its original format. Similarly, documents can be imported from the desktop by the Gatekeeper or Processor(s). Most any file type may be imported, e.g., word processor, spreadsheet, PDF.

Defining Document Statuses

Any of the document attributes can be updated by the Gatekeeper or Processor. Values for the process and status attributes can be limited to those defined by the Gatekeeper and the system reserved values (In-Basket for Process and New for Status). In embodiments, remaining values will not be validated. As described above, the ability to add freeform notes to a document is provided. Annotations can be added, modified and removed from TIFF images. These notes and annotations are available to most anyone viewing the document.

Documents can be printed via an image viewer, e.g., an eClient image viewer. Most any print driver available on the desktop can be selected thus providing for fax capability as needed. The ability to search for documents is provided. The user is able to specify one or more attribute values and use wildcards to narrow the documents displayed. The resulting list of documents can be sorted on any attribute. The number of documents returned for a search can be limited by the system defined result set limit.

The ability to view the document in its native format is provided. The system 400 launches the appropriate viewer or program based on the mime type/document extension. The user can view the annotations for the document. Documents are date- and time-stamped when added to the system and when updated. The system 400 can version change to the attributes of a document. This allows the business unit to track what was changed from one version to the next. Events can be viewed via the history, e.g., eClient View History function. Changes between versions can be seen via the eClient View Version Information function. The ability to display notes associated with documents is also provided.

Still further, the ability to identify the input channel that introduced the document as well as channel specific information is provided in the Capture Research Data field. Input channels are described infra.

Repository Requirements

In accordance with the example of FIG. 4, three item types are used: a Process Definition item type containing valid processes a document can be assigned to, a Document item type to contain the actual documents and a Status Definition item type containing all valid Status values for documents.

Turning first to the Process Definitions Item type, this type defines each valid process name used to organize the work. The Process Definitions item type contains the process names used with the appliance. The descriptive name of the Process Definitions item type can be set from the appliance order and includes the Appliance Id for easy and efficient identification. The retention period for Process Folders is most often permanent. The Process Definitions item type will be defined as a document item type to allow it to be maintained via eClient. It will be restricted to prevent the storage of documents. It is to be understood and appreciated that the Process Definitions item type supports notes.

The retention period for the item type can be permanent. The Gatekeeper can manually delete Status entries as needed. With regard to attributes, the Process Folder item type will have two attributes defined for identifying folders. In examples, no validation is performed on any of the attributes. For instance, the process attribute contains the business defined process name. It is set up as required but is not unique.

With regard to access rights item level security will be used for this item type so that the system reserved value of “In-Basket” can be protected. The initial “In-Basket” value will be created by the system administrator with a special ACL which prevents a non-administrator from deleting it. The need for item level security is due to the foreign key definition, e.g., the system input services must have the New status defined or they will fail when adding document.

The Gatekeeper can create, read, update and delete process definitions as well as have full access to the notes associated with a document or folder. However, the Gatekeeper will not have access to the document part which will prevent documents from being added to the Process Definitions item type. This item type can be used in a foreign key association to limit the selection of processes for a document. As such, a process cannot be renamed or deleted if a document contains its value. Additionally, the process “In-Basket” is a system reserved value and cannot be renamed or deleted.

The Processor, Researcher and DSR personnel can have read access to process definitions and to folder notes. Similarly, CM Support personnel can have create, read, update and delete access for the Process Definition and its notes.

The Document item type contains the actual documents for the appliance. Documents can be added via most any of the established input channels (e.g., facsimile, electronic mail, desktop) as indicated on the appliance order form or otherwise appropriate. The Document item type contains the documents to be stored in the appliance. The descriptive name of the Document item type is set from the appliance order and includes the Appliance Id for easy identification. The Document item type supports annotations and notes.

The retention period for the item type is set from the appliance order. All documents in the Document item type have their expiration date set as the date created plus the item type retention period. In aspects, there is no facility to extend the expiration of a document although it can be reintroduced as a new document if needed. The Gatekeeper has the ability to manually delete individual documents prior to their expiration date. Once a document's expiration date is reached, the system can automatically remove the document from the system, regardless of any attribute value or presence in a Process folder.

The Process item type will have the following attributes, as defined in the following table and order. It is to be understood that validation need not be performed on any of the attributes.

| Attribute | Description |
|---|---|
| Subject | This contains the business defined subject for the document, e.g., |
| | Lastname, Firstname or Account Number or Reference. |
| | It is set up as optional. It will be indexed. |
| DocDesc | This contains the business defined description for the document, e.g., |
| | New Account or Monthly Statement. It is set up as optional and |
| | allows the maximum number of characters using the extended |
| | alphanumeric character set. |
| WorkPriority | This contains the business defined priority for the document, e.g., |
| | High, Low or 1-5. |
| | It is set up as optional. |
| Status1 | This is the business defined Status for the document. |
| | It is set up as required with a default value of “New” to allow new |
| | folders to be identified. It will be defined as an index. A foreign key |
| | for this attribute will be defined to the Status item type and presented |
| | in a drop down list for selection. |
| OwnerName | This contains the business defined owner for the document, e.g., |
| | Corporate ID, Department Name or Branch. It is set up as optional |
| | and allows the maximum number of characters using the extended |
| | alphanumeric character set. |
| Process | The Process to which the document is to be sent. |
| | It is set up as required with a default value of “In-Basket” to allow |
| | delivery of new documents. It will be defined as an index. A foreign |
| | key for this attribute will be defined to the Process Definitions item |
| | type and presented in a drop down list for selection. |
| Cap_Rsrch_Data | For system managed input sources, the system fills in channel specific |
| | information about the document. |
| | It is set up as optional. |

The following table illustrates example access rights with respect to role and responsibility in accordance with aspects of the innovation.

| Role | Responsibility |
|---|---|
| Gatekeeper | Full access to create, read, update and delete documents and their |
| | attributes. Create and read access to the notes. Full access to annotations. |
| Processor | Read and update access to the document and its attributes. Create and |
| | read access to the notes. Full access to annotations. |
| Researcher | Read access to the document, notes and annotations. |
| DSR | DSR Support Personnel have create, read, update and delete access for the |
| | document and its attributes. |
| CM Support | Content Manager Support personnel have create, read, update and delete |
| | access for the document and its attributes. |
| SystemInput | Consists of Trusted IDs used by the system input devices (including DSR |
| | store trusted id). Have create and update access for the document and its |
| | attributes. |

Status Definitions Item Type

The Status Definitions item type contains the Status values defined by the Gatekeeper. It will be used to provide values for the Status attribute dropdown. Status values will be created via the eClient Create Folder function.

The Status Definitions item type contains the status values used with the appliance. The descriptive name of the Status Definitions item type will be set from the appliance order and includes the Appliance Id for easy identification and the type supports freeform notes. In order for the item type to appear on the eClient item type list, it will be defined as a document type but access will be restricted to prevent the storage of documents. The retention period for the item type will be permanent. The Gatekeeper can manually delete Status entries as needed or otherwise appropriate.

The Status Definitions item type will have the following attributes defined in the following order, as shown in the table below. In aspects, validation need not be performed on any of the attributes.

| Attribute | Description |
|---|---|
| Status1 | Business defined status value to appear as a dropdown |
| | selection wherever the Status attribute can be edited. The |
| | system reserved value “New” will always be |
| | available for new documents. |
| | Do to the low number of entries in this item type, no indexes |
| | will be defined. |
| Comments | A freeform comment describing the status. |

With regard to access rights, item level security will be used for this item type so that the system reserved value of “New” can be protected. The initial “New” value will be created by the system administrator with a special ACL which prevents a non-administrator from deleting it. The need for item level security is due to the foreign key definition, e.g., the system input services must have the New status defined or they will fail when adding document.

The following table illustrates roles associated with this type in accordance with aspects of the innovation.

| Role | Responsibility |
|---|---|
| Gatekeeper | Create, read, update and delete access to the metadata |
| | and Notes. No access to the base part thereby limiting |
| | entries to folders only. Read access to the system |
| | reserved value of New. |
| Processor | Read access to the document (folder) and notes.. |
| Researcher | Read access to the document (folder) and notes. |
| DSR | Read access to the document (folder) and notes. |
| CM Support | Content Manager Support personnel have create, read, |
| | update and delete access to all documents and notes. |
| SystemInput | Consists of Trusted IDs used by the system input devices |
| | (including DSR store trusted id). Read access to the |
| | document (folder) and notes. |

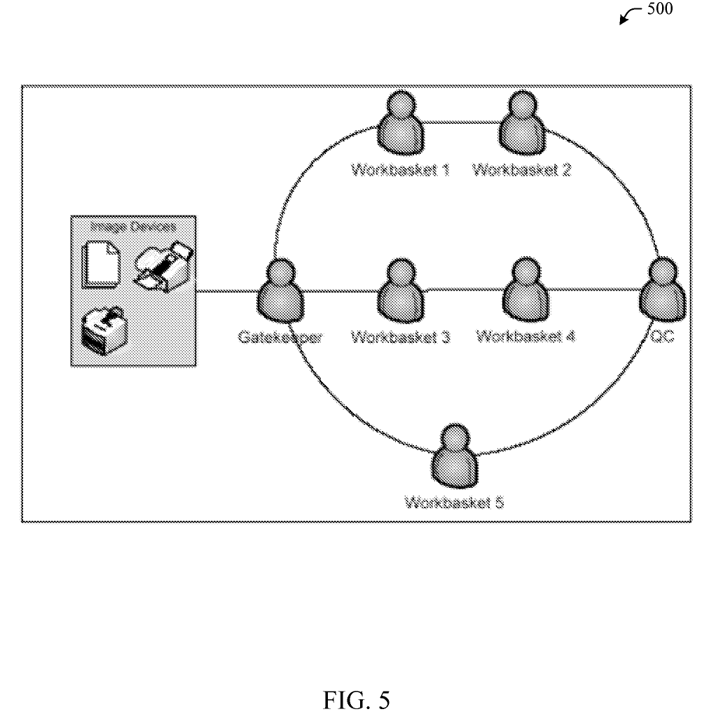

Referring now to FIG. 5, a diagram of an appliance 500 which illustrates an entry level document routing appliance is shown. While similar to the appliances of FIG. 4, appliance 500 can automatically push work and assignments to processors based on business-defined priorities or other pre-defined rules. It will be appreciated and understood that this functionality ensures that priority work is handled first rather than letting processors ‘cherry pick’ their work.

The system automatically delivers new documents to the In-Basket. The Gatekeeper examines the document, updates any attributes as desired and routes the document to the appropriate workbasket for processing. As described above, the examination (evaluation or analysis) can be performed manually or automatically as appropriate or desired.

Processors access their assigned worklist(s) and the system automatically pushes the next item to them. They view the document and perform appropriate actions in other systems. They can update document's attributes as appropriate. They can route the document to another workbasket or remove the document from processing. The system need not enforce any routing policies so the business is free to change their processes as needed or otherwise desired.

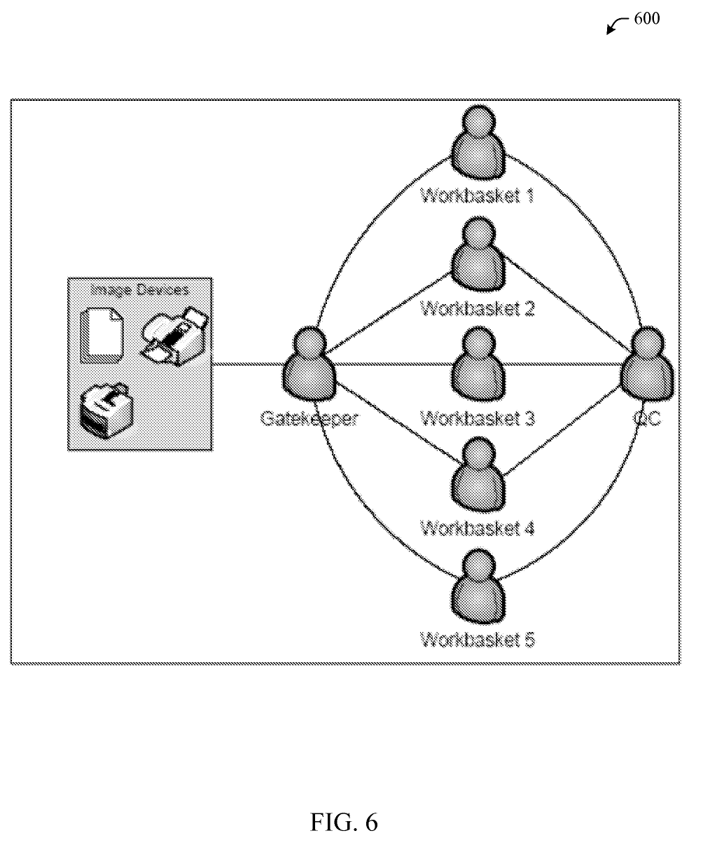

FIG. 6 illustrates an alternative diagram of a system 600 in accordance with aspects of the innovation. As illustrated, the Gatekeeper can manually (or automatically) route documents to an appropriate workbasket for processing.

Documents can be retrieved by searching on any of the attributes, making it easy to locate for research purposes. In aspects, the systems (500, 600) can be delivered with a predefined in-basket and up to nine (9) business defined workbaskets. However, it is to be understood that other aspects exist which are to be included within the scope of the innovation and claims appended hereto.

In accordance with the innovation, flexible routing enables a business decide how documents will flow through workflow processes. Thus, two disparate system examples are shown in FIGS. 5 and 6 respectively.

In accordance with the examples, work assignments are automatically pushed to processors based on either priority or age. As well, assignments can be pushed based upon other factors including, but not limited to, processor availability, processor knowledge, topic, etc.

In addition to managing workflow, the systems (500, 600) can establish reports that provide the number of processes started and completed each day. Thus, management can easily see how many documents are in each step of a process. Documents can be labeled with the most any criteria including, but not limited to, Subject, Document Description and Status. Further, processors can add Notes to documents and Annotate images as desired or appropriate.

In accordance with the systems (500, 600) the following table illustrates primary responsibilities in associated with each role. It is to be understood that these responsibilities are exemplary and that other aspects exist which assign different or additional responsibilities to alternative roles without departing from the spirit and/or scope of the innovation and claims appended hereto.

| Role | Primary Responsibility |
|---|---|
| Gatekeeper | The Gatekeeper role is the controlling role for the appliance. The |
| | Gatekeeper monitors the In-Basket and reviews, updates and routes new |
| | documents to the appropriate workbasket. Gatekeepers can import new |
| | documents, override checkouts and delete documents. |
| Processor | The Processor role is responsible for the main work performed on a |
| | document. They view documents, perform any related work, update |
| | document attributes or notes as needed and annotate images as needed. |
| Researcher | The researcher role is responsible for answering inquiries such as assisting |
| | auditors by locating required documents or providing status updates. |
| | Researchers have read access to the documents as well as information on |
| | where the document is in the process. |

The appliance functions are grouped into the categories below. Each function indicates the role(s) that can access that function.
Working with Workbaskets
Working with Documents

Working with Workbaskets

When a document is in a workbasket, it is referred to as a ‘workitem.’ With the exception of the ‘All Items’ and ‘Suspended’ worklists, each workbasket is its own worklist.

All documents flow into the In-Basket as workitems. Here, Gatekeepers review the workitem, update any attributes as appropriate, and determine the priority of a workitem and the initial workbasket it is sent to. Gatekeepers can adjust the priority of a workitem as needed at any time in the process.

The system automatically pushes workitems to Processors, for example, based on the order established by the business unit. When the processor finishes their work on a workitem, they can route it to another workbasket or complete it depending on the business process.

When all work on the workitem is complete, the workitem is routed to “Complete.” The system removes the workitem. The business processes specify when a workitem can be considered complete. The Gatekeeper has the ability to list all workitems in the appliance through the ‘All Items’ worklist. The ability to sort the list of documents on any attribute value is provided.

The Suspended worklist shows all suspended documents. Gatekeepers and Processors can access this list to locate documents they suspended. The ability to sort the list of documents on any attribute value is provided. Gatekeepers and Processors select their assigned worklist and the next available document is automatically checked out and displayed to them. When a business or unit orders the appliance, they indicate for each worklist if the next available document is selected based on FIFO (first in, first out) or Priority order. The exceptions to this are the ‘All Items’ and ‘Suspended’ worklists.

The appliance allows workitems to be routed to most any workbasket from within most any other workbasket. The business rules dictate the appropriate process flow for the document. Gatekeepers have the ability to set the processing priority of a document in a workbasket. The Gatekeeper is able to put a completed document back in the In-Basket where it can be sent through for reprocessing.

Workitems can be suspended, for example, if there are issues that would prevent the Processor from completing the work. These items are available through the ‘Suspended’ worklist. The processor can work the item there and route it to the next point in processing which will automatically resume the item.

All of the functional roles are able to search and display documents and their associated notes, annotations and history. Processors and Gatekeepers can update the documents as they are processed. Gatekeepers are permitted to perform restricted functions such as canceling checkouts and deleting documents. To support the various roles, the following functions will be provided.

Checking out a document prohibits other users from updating it until it is checked back in. The ability to cancel the checkout on any document is provided. Normal workbasket processing will automatically check-out and check-in documents. However, there are instances where manual control may be needed, so the system provides a check-out/check-in mechanism to allow the business to synchronize access to the documents. Once the user completes the work, the ability to check-in the document is needed or otherwise desired.

The ability to permanently delete a document prior to its defined expiration is provided. Most often, this functionality is limited to the Gatekeeper. The ability to export documents from a process folder is also provided. The file will be exported in its original format. Documents can be imported from the desktop. Most any file type may be imported, e.g., word processor, spreadsheet, PDF. The system will automatically add the document to the current process folder if one is open.

In accordance with aspects, any of the document attributes can be updated. Values for the Status attribute will be limited to those defined by the Gatekeeper and the system reserved status of New. Remaining values will not be validated. The ability to add and read freeform notes to a document is provided. Annotations can be added to TIFF images. These notes and annotations can be made available to anyone viewing the document. Documents can be printed, for example, via the eClient image viewer. Essentially any print driver available on the desktop can be selected thus providing for fax capability as needed.

The ability to search for documents is provided. The user is able to specify one or more attribute values and use wildcards to narrow the documents displayed. The resulting list of documents can be sorted on any attribute. The number of documents returned for a search can be limited by the system defined result set limit.

The ability to view the document in its native format is provided. The system will launch the appropriate viewer or program based on the mime type/document extension. The user is able to view the annotations for the document. Documents are date- and time-stamped when added to the system, updated and routed among workbaskets. The system will capture version changes to the attributes of a document. This allows the business unit to track what was changed from one version to the next. Events can be viewed via the eClient View History function. Changes between versions can be seen via the eClient View Version Information function.

Still further, the ability to display notes associated with documents is provided. The ability to identify the input channel that introduced the document as well as channel specific information is provided in the Capture Research Data field.

Repository Requirements

A single document item type is used to contain the actual documents. A document routing definition is created to provide the routing.

Document Item Type

The Document item type contains the actual documents for the appliance. Documents can be added via most any of the established input channels as indicated on the appliance order form or otherwise specified. The Document item type includes the documents to be stored in the appliance. The descriptive name of the Document item type is set from the appliance order and includes the Appliance Id for easy identification. The Document item type supports annotations and notes.

The retention period for the item type is set from the appliance order. All documents in the Document item type have their expiration date set as the date created plus the item type retention period. There is no facility to extend the expiration of a document, although it can be reintroduced as a new document if needed. The Gatekeeper has the ability to manually delete individual documents prior to their expiration date. Once a document's expiration date is reached, the system will automatically remove the document from the system, regardless of any attribute value or presence in a worklist.

The Document item type has the following attributes defined in the following order (as illustrated in the table below). In aspects, no validation is performed on any of the attributes.

| Attribute | Description |
|---|---|
| Subject | This contains the business defined subject for |
| | the document, e.g., Lastname, Firstname or |
| | Account Number or Reference. |
| | It is set up as optional. It will be indexed. |
| DocDesc | This contains the business defined description for |
| | the document, e.g., New Account or Monthly |
| | Statement. |
| | It is set up as optional. |
| Status1 | This contains the business defined status for |
| | the document, e.g., Inprocess or Complete. |
| | It is set up as optional. It will be indexed. |
| Cap_Rsrch_Data | For system managed input |
| | sources, the system fills in channel specific |
| | information about the document.. |
| | It is set up as optional. |

In the described embodiment, the Document item type will be set up to automatically start the document on the related process (see below).

| Process Name | The Process name is taken from the Item type name replacing | |
|---|---|---|
| | the leading i with p. | |
| Workbaskets | There is a pre-defined In-Basket and up to nine (9) user defined | |
| | workbaskets. | |
| | Logical | |
| | Name | How defined |
| | In-Basket | First step in the process where all new documents |
| | | are delivered. |
| | Node1 | User defined name taken from appliance order. |
| | Node2 | User defined name taken from appliance order. |
| | Node3 | User defined name taken from appliance order. |
| | Node4 | User defined name taken from appliance order. |
| | Node5 | User defined name taken from appliance order. |
| | Node6 | User defined name taken from appliance order. |
| | node7 | User defined name taken from appliance order. |
| | node8 | User defined name taken from appliance order. |
| | node9 | User defined name taken from appliance order. |
| Routing | The routing is configured, e.g., any workbasket can route to | |
| | any other workbasket or to the end (Complete). | |
| Worklists | Each workbasket will be a worklist. In addition, there will be | |
| | an ‘All Items’ and ‘Suspended’ worklist. | |
| | Logical | |
| | Name | How defined |
| | All Items | Contains all workitems from workbaskets. |
| | | Gatekeeper access only. |
| | In-Basket | Named In-Basket. Setup as a ‘push’ worklist in |
| | | FIFO order. Gatekeeper access only |
| | Suspended | Named Suspended and contains all suspended items |
| | | from all workbaskets. Gatekeeper and Processor |
| | | access. |
| | node1 | Name taken from appliance order. Setup as a ‘push’ |
| | | worklist. Order (priority or date) determined from |
| | | the appliance order. Gatekeeper and Processor |
| | | access. |
| | node2 | Name taken from appliance order. Setup as a ‘push’ |
| | | worklist. Order (priority or date) determined from |
| | | the appliance order. Gatekeeper and Processor |
| | | access. |
| | node3 | Name taken from appliance order. Setup as a ‘push’ |
| | | worklist. Order (priority or date) determined from |
| | | the appliance order. Gatekeeper and Processor |
| | | access. |
| | node4 | Name taken from appliance order. Setup as a ‘push’ |
| | | worklist. Order (priority or date) determined from |
| | | the appliance order. Gatekeeper and Processor |
| | | access. |
| | node5 | Name taken from appliance order. Setup as a ‘push’ |
| | | worklist. Order (priority or date) determined from |
| | | the appliance order. Gatekeeper and Processor |
| | | access. |
| | node6 | Name taken from appliance order. Setup as a ‘push’ |
| | | worklist. Order (priority or date) determined from |
| | | the appliance order. Gatekeeper and Processor |
| | | access. |
| | node7 | Name taken from appliance order. Setup as a ‘push’ |
| | | worklist. Order (priority or date) determined from |
| | | the appliance order. Gatekeeper and Processor |
| | | access. |
| | node8 | Name taken from appliance order. Setup as a ‘push’ |
| | | worklist. Order (priority or date) determined from |
| | | the appliance order. Gatekeeper and Processor |
| | | access. |
| | node9 | Name taken from appliance order. Setup as a ‘push’ |
| | | worklist. Order (priority or date) determined from |
| | | the appliance order. Gatekeeper and Processor |
| | | access. |

Below is an example of access rights roles and responsibilities:

| Role | Responsibility |
|---|---|
| Gatekeeper | Full access to create, read, update and delete documents and their |
| | attributes. Create and read access to the notes. Full access to annotations. |
| | The ability to manually start documents on a process as well as set priority |
| | for documents. Ability to check-in documents checked out by other |
| | users. Ability to access and process document routing worklists including |
| | suspend/resume of workitems. Ability to access All Items worklist. |
| Processor | Read and update access to the document and its attributes. Create and |
| | read access to the notes and full access to annotations. Ability to access |
| | and process document routing worklists including suspend/resume of |
| | workitems. |
| Researcher | Read access to the document, notes and annotations. |
| DSR | DSR Support Personnel have create, read, update and delete access for the |
| | document and its attributes. |
| CM Support | Content Manager Support personnel have create, read, update and delete |
| | access for the document and its attributes. Ability to check-in documents |
| | checked out by other users. Ability to access and process document |
| | routing worklists including suspend/resume of workitems. Ability to |
| | access All Items worklist. |
| SystemInput | Consists of Trusted IDs used by the system input devices (including DSR |
| | store trusted id). Have create and update access for the document and its |
| | attributes. |

Status Definitions Item Type

The Status Definitions item type contains the Status values defined by the Gatekeeper. It will be used to provide values for the Status attribute dropdown. Status values will be created via the eClient Create Folder function.

The Status Definitions item type contains the status values used with the appliance. The descriptive name of the Status Definitions item type will be set from the appliance order and includes the Appliance Id for easy identification. The Status Definitions item type supports freeform notes. In order for the item type to appear on the eClient item type list, it will be defined as a document type but access will be restricted to prevent the storage of documents.

The retention period for the item type will be permanent. The Gatekeeper will manually delete Status entries as needed.

The Status Definitions item type will have the following attributes defined in the following order and as shown in the table below. In aspects, no validation is performed on any of the attributes.

| Attribute | Description |
|---|---|
| Status1 | Business defined status value to appear as a dropdown |
| | selection wherever the Status attribute can be edited. |
| | The system reserved value “New” will be available for new |
| | documents. |
| | Do to the low number of entries in this item type, no |
| | indexes will be defined. |
| Comments | A freeform comment describing the status. |

Item level security will be used for this item type so that the system reserved value of “New” can be protected. The initial “New” value will be created by the system administrator with a special ACL which prevents a non-administrator from deleting it. The need for item level security is due to the foreign key definition, e.g., the system input services must have the New status defined or they will fail when adding document.

| Role | Responsibility |
|---|---|
| Gatekeeper | Create, read, update and delete access to the metadata |
| | and Notes. No access to the base part thereby |
| | limiting entries to folders only. Read access to |
| | the system reserved value of New. |
| Processor | Read access to the document (folder) and notes. |
| Researcher | Read access to the document (folder) and notes. |
| DSR | Read access to the document (folder) and notes. |
| CM Support | Content Manager Support personnel have create, read, |
| | update and delete access to all documents and notes. |
| SystemInput | Consists of Trusted IDs used by the system input devices |
| | (including DSR store trusted id). Read access to the |
| | document (folder) and notes. |

Following is an exemplary definition of attributes:

| | Descriptive | |
|---|---|---|
| Attribute Name | Name | Definition |
| Cap_Rsrch_Data | Capture | This is an existing attribute. |
| | Research | |
| | Data | |
| CaseName | Case Name | This is a new attribute to be defined as |
| | | VarChar(175), Extended Alphanumeric. |
| DocDesc | Document | This is an existing attribute. |
| | Description | |
| Owner | Owner | This is a new attribute to be defined as |
| | | VarChar(64), Extended Alphanumeric. |
| PeriodEnding | Period | This is a new attribute to be defined as |
| | Ending | VarChar(64), Extended Alphanumeric. |
| Process | Process | This is a new attribute to be defined as |
| | | VarChar(175), Extended Alphanumeric. |
| Status1 | Status | This is a new attribute to be defined as |
| | | VarChar(64), Extended Alphanumeric. |
| Subject | Subject | This is a new attribute to be defined as |
| | | VarChar(200), Extended Alphanumeric. |
| WorkPriority | Work | This is a new attribute to be defined as |
| | Priority | VarChar(64), Extended Alphanumeric. |

Input Channels

When the appliance is ordered, the business unit can specify the input channels and locations that the system should capture and deliver to the In-Basket folder. The ordering process is to automatically create the necessary capture components as described below.

The eMail channel is indicated on the appliance order by checking Lotus Notes, Microsoft Outlook, or the like, and providing specific server & mailbox addresses under each mail system. The system input processor moves all documents from the specified mailboxes to the Document item type, adds them to the In-Basket folder and removes them from mailboxes. Attachments are added to the Document item type separately under the same subject information.

The Subject attribute is set to the subject line of the email. The Capture Research Data can be formatted as follows:

eMail From: from emailid To: to emailid Received: timestamp

| | |
|---|---|
| from emailid | The sender's email address as provided by the mail system |
| to emailid | The receiver's email address as provided by the mail system |
| timestamp | The timestamp when the email was received as provided |
| | by the mail system. |

The fax channel is indicated on the appliance order by checking RightFax and providing specific fax numbers to be captured. In aspects, fax numbers can be limited to numbers in the enterprise (e.g., RightFax environment). The system input processor moves documents from the specified RightFax fax number to the Document item type, adds them to the In-Basket folder and remove them from RightFax.

The Capture Research Data will be formatted as follows:

FAX From: from faxid To: to faxid Pages: nn Received: timestamp

| | |
|---|---|
| from faxid | The sender's fax number of station id as captured by RightFax |
| to faxid | the receiving fax number of station id as captured by RightFax |
| nn | The number of pages in the fax as captured by RightFax |
| timestamp | The timestamp when the fax was received as |
| | provided by RightFax. |

The MFD (multi-function devices) channel is indicated on the appliance order by checking MFD and providing MFD network name. A capture process, named after the appliance, is sent to the front operator panel of the specific MFD. MFD users login and select the capture process from the MFD panel selection to send their document to the appliance. The system input processor captures the document, adds it to the Document item type and adds the document to the In-Basket folder.

The Capture Research Data will be formatted as follows:

Scan From: scan_userid Device: MFD_Devicename Pages:
nn Received: timestamp

| | |
|---|---|
| scan_userid | The userid that scanned the document as captured |
| | by the MFD. |
| MFD_Devicename | The network devicename of the MFD |
| nn | The number of pages in the document after image |
| | cleanup. |
| timestamp | The timestamp when the document was scanned. |

Central Scan is indicated on the appliance order by checking Central Scan (DSR) option. A capture process, named after the appliance, is generated for use by DSR. Documents sent to DSR for central scanning are identified as ImageXpress and the Appliance name. The capture process adds documents to the Document item type and links each to the In-Basket folder.

The Capture Research Data will be formatted as follows:

DSR: Pages: nn dsr_research_string

| | |
|---|---|
| nn | The number of pages in the document after |
| | image cleanup. |
| dsr_research_string | The DSR capture research string. |
| | Internal use by DSR for researching scanning issues. |

Input from the desktop is always allowed for Gatekeepers using the eClient Import function. The Capture Research Data contains the filename that was uploaded minus any directory information. The uploaded document is added to the In-Basket folder

The Capture Research Data will be formatted as follows:

Desktop: filename

| | |
|---|---|
| filename | The filename of the uploaded file, minus any |
| | directory information. |

Reporting

Reporting for Image Appliances can be enabled by subscribing to real-time event records from the repository and constructing summary reporting data. Additional data will be obtained from queries against specific CM tables. Most all Image Appliance reports are delivered electronically via web interfaces. In addition to viewing the reports, the data will be available for downloading to file for further processing. In aspects, daily reports will be kept for 60 days. Gatekeepers have access to the reports for their appliances. Additionally, Service Delivery and Support personnel have access to all appliance reports.

It is to be understood that most any reports can be generated which convey statistics associated with the system. For example, daily activity reports can be generated which provide a breakdown by item type. The report can provide the number of documents added, updated, viewed (when available) and deleted on a given day. Additionally, the number of unique users accessing the item type on a give day can also be provided. Still further, the total number of documents and total space used can be provided. It is to be understood and appreciated that reports can be specific to each appliance, for example, appliances illustrated in FIGS. 2, 4, 5 and 6.

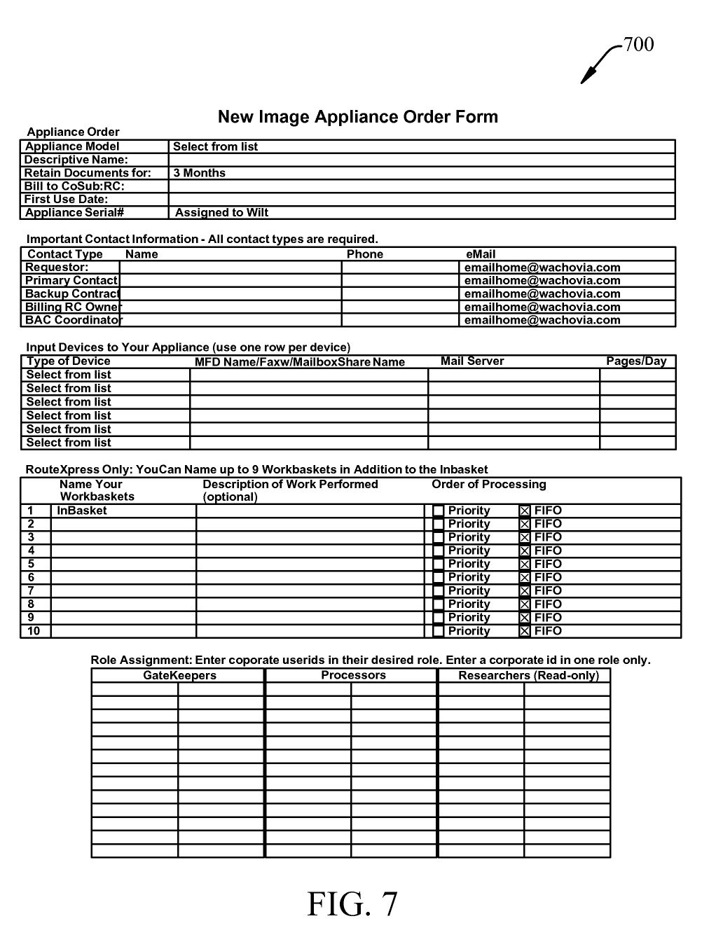

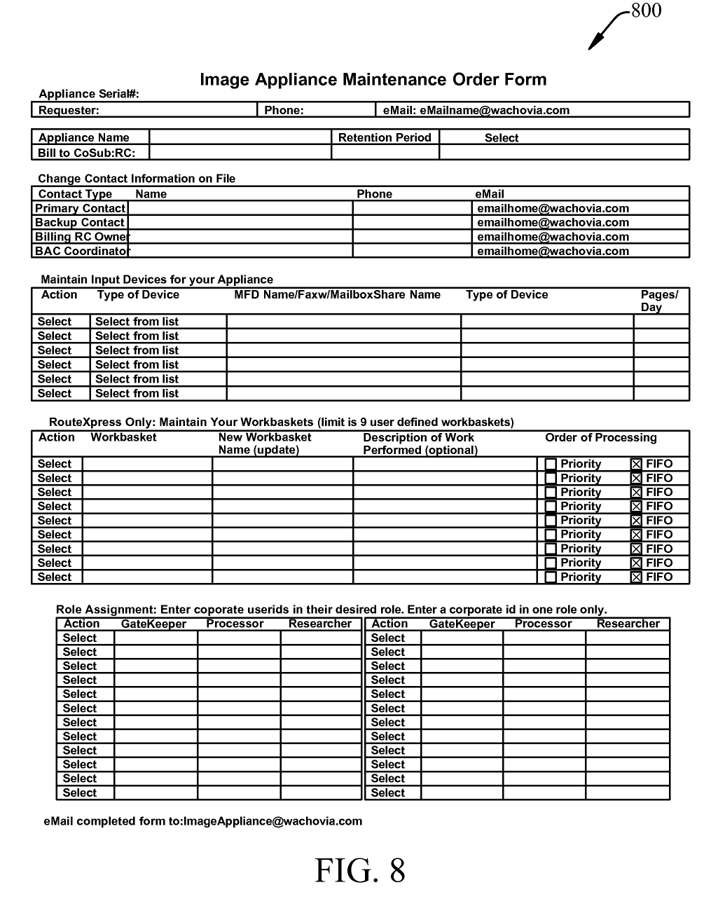

In aspects, appliance order and maintenance forms can be used to convey information related to a particular appliance. Examples of such forms are form 700 and 800 illustrated in FIGS. 7 and 8 respectively. It is to be understood that a large portion of the request forms can be automated as desired or appropriate. For instance, the system can retain previously entered information and auto-fill as appropriate.

Referring first to the exemplary New Image Appliance Order Form 700 of FIG. 7, when a customer orders an appliance, they will provide the following information:
Appliance model: CaseXpress, ImageXpress or RouteXpress.
Business selected appliance name.
Retention period for the documents and if there is a storage requirement.
Bill to RC (Responsibility Center for internal chargeback purposes).
Date to become active.
Requestor's Name, eMail and Phone#.
Primary Contact Name, eMail & Phone# (for notification of outages and other events).
Backup Contact Name, eMail & Phone# (for notification of outages and other events).
RC Owner Contact Name, eMail & Phone#.
BAC (Business Access Coordinator) Contact Name, eMail & Phone#.
Input Channel(s) to be captured. Multiple channels and instances within a channel can be capture.
   For Fax, the RightFax inbound fax number. All faxes can be captured to the appliance and deleted.
   For eMail, the Notes or Outlook Mail Server and Mailbox. All eMails can be captured to the appliance and deleted.
   For MFD, the MFD Device name. A Scan icon will be added to the device or coordination with Desktop services to obtain the document.
   For Shared Directories, the UNC (Universal Naming Convention) pathname of the share. All files in the shared directory will be captured to the appliance and deleted from the directory.
   For Central Scan, the location where documents arrive.
   For all input channels, the estimated average daily page volume for estimating costs and storage requirements.
For RouteXpress, the requestor will provide the workbasket names (up to 9 workbaskets) and how each basket will be processed (FIFO or Priority).
Corporate userids by Role: Gatekeeper, Processor, Researcher. Most often, a Userid can exist in only one role.

With regard to processing the appliance order, once the order is received, a reviewer can perform the following, in accordance with a specific aspect:
Obtain approval from RC approver.
Upon approval, create an inventory item within the system, assigning the next sequential appliance id to the appliance. The ‘Bill To’ RC is to be entered into the Financial information of the inventory item to assist with chargeback. The inventory item is to be linked to the overarching Image Appliance application (internally referred to as C3).
Ensure the fax number or email is not currently listed as being used with another appliance. Notify requester to resolve. Fax numbers and mailboxes can only be used by one appliance.
If central scan is requested, contact the DII (Document Image & Integration) representative to set up the DSR (Document Storage & Retrieval) job.
Generate the XML (eXtended Markup Language) to perform the CM setup, create the new zOS collections, define the DB2 item table.
Update the request with the RACF (Resource Access Control Facility) functional groups.
Contact the BAC listed on the order and request that they connect the named users to the needed functional groups.

Continuing with the aforementioned example and with regard to delivering the order, once the order has been processed, the requestor is notified of the appliance serial number. Prior to the delivery date, the WIIT (Workflow Image & Integration Technologies) Advocate will work with the business unit to ensure their business processes are ready for the appliance and that training has been conducted in the WIIT Training system.

On the day of delivery, WIIT personnel will complete delivery by:
Activating the input channels to begin capture from the designated input devices.
Coordinate with DSR if central scanning was requested.
Ensure input is properly flowing into the device.
Obtain signoff from the business unit that the appliance is working.

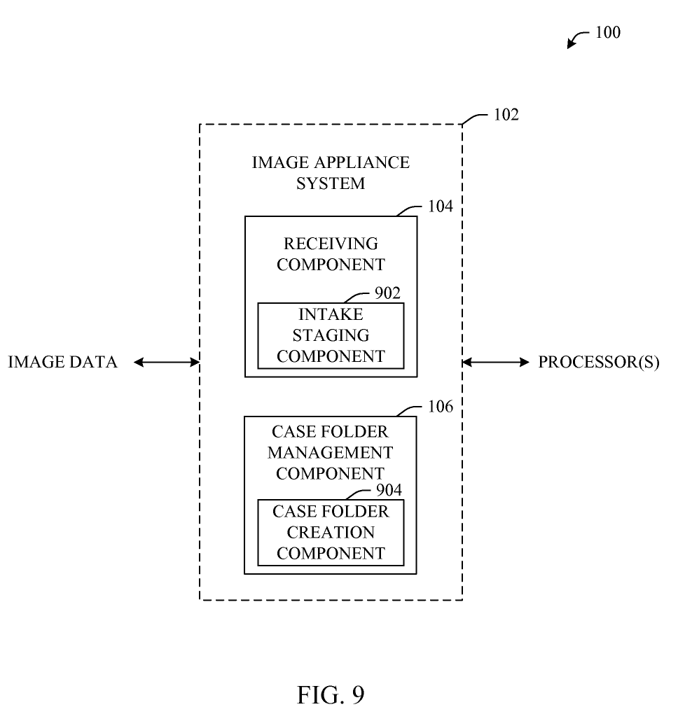

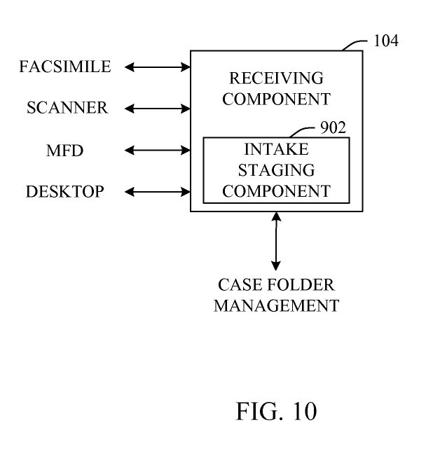

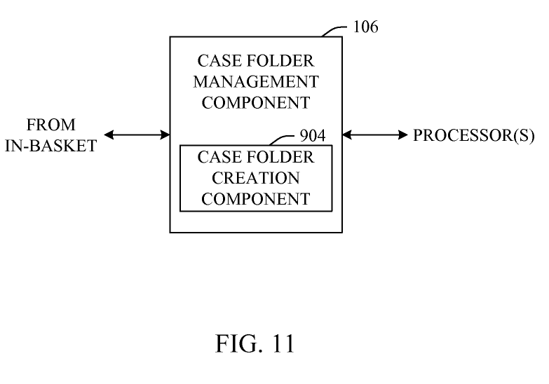

Referring now to FIG. 9, there is illustrated an alternate example block diagram of system 100 in accordance with the innovation. As shown, the receiving component 104 can include an intake staging component 902. Similarly, the case folder management component 106 can include a case folder creation component 904. Examples of each of these sub-components are illustrated in FIGS. 10 and 11 that follow.

Referring first to FIG. 10, an example aspect of a receiving component 104 that employs an intake staging component 902 is shown. As illustrated, the receiving component 104 can accept (or otherwise obtain) data (e.g., image data) from a plurality of input sources. As shown in the embodiment of FIG. 4, input devices can include, but are not limited to, facsimile, scanner, MFD, desktops, or the like. Accordingly, the intake staging component 902 (e.g., in-basket) can manage the inputs while managing transmission or delivery to the case folder management, as shown.

An example case folder management component 106 is shown in FIG. 11. As illustrated, the case folder management component 106 can include a case identification component 904. As described in greater detail supra, this case identification can employ OCR, pattern recognition or the like to identify a particular case folder by which to insert document(s) from the in-basket. As well, it is to be understood that this identification process can be manual as appropriate or otherwise desired.

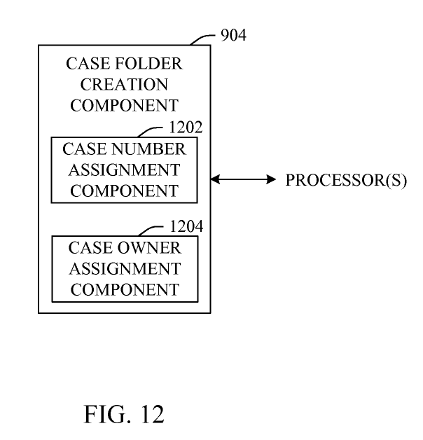

FIG. 12 illustrates an example case identification component 904 in accordance with aspects of the innovation. As shown, the case identification component 904 can include a case number assignment component 1202 and a case owner assignment component 1204. In operation, these sub-components 1202 and 1204 can facilitate accomplishment of the above-described functionalities. In particular aspects, the case number assignment component 1202 can be employed in folder establishment whereas the case owner assignment component 1204 can be employed in identifying an appropriate processor or owner for a folder. It is to be understood that other aspects, for example those which do not assign a specific processor, need not employ a case owner assignment component 1204 as described. Rather, these aspects can employ component(s) (not shown) which record owner information once a folder is accepted or otherwise worked on by a processor.

As described above, users such as processors can employ a user interface (UT) 1302 to search for documents, folders, etc. The UT 1302 can be used to interface with the case folder management component 106 whereby information within a store 1304 can be accessed, modified, deleted or the like. As shown, the case folder management component 106 can include a search component 1306, a retrieval component 1308 and a modification component 1310. Each of these sub-components (1306, 1308, 1310) can process requests/instructions received by way of the UT 1302 to locate, access and modify records (e.g., documents, folders) respectively. Features, functions and benefits of the case folder management component 106 are described in greater detail supra.

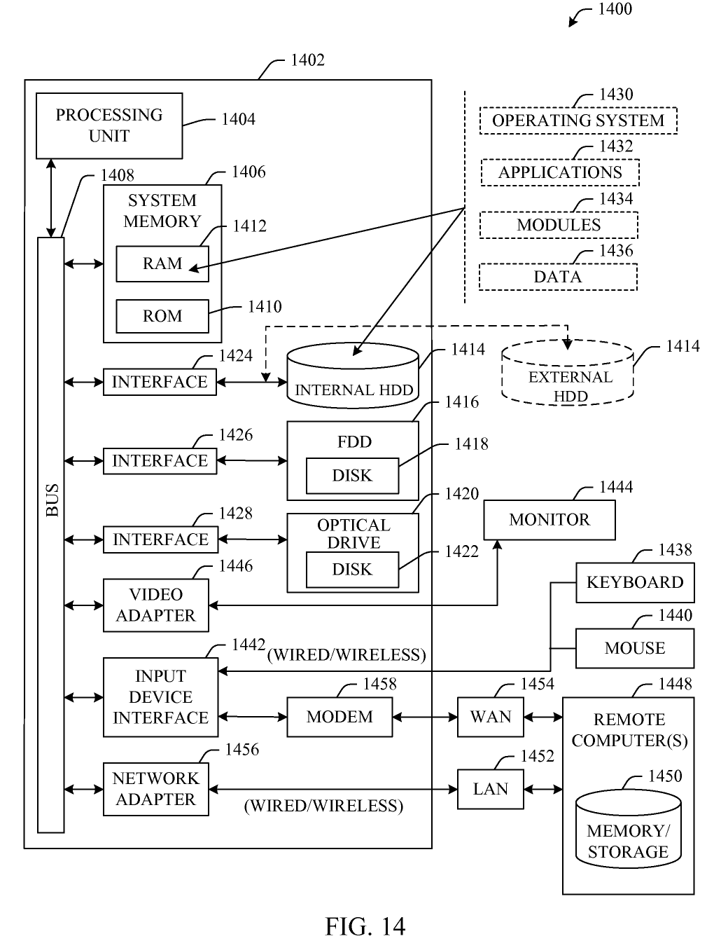

Referring now to FIG. 14, there is illustrated a block diagram of a computer operable to execute the disclosed architecture. In order to provide additional context for various aspects of the subject innovation, FIG. 14 and the following discussion are intended to provide a brief, general description of a suitable computing environment 1400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects of the innovation includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates seamless image data management by way of an image appliance, comprising:
a receiving component that accepts image data into the image appliance via a plurality of input sources; and
a repository management component that processes the image data and makes a portion of the image data available to a processor.

2. The system of claim 1, wherein the plurality of input sources includes at least one of a facsimile, scanner, multi-function device, email account or desktop.

3. The system of claim 1, the image appliance facilitates basic case management associated with the image data.

4. The system of claim 1, the image appliance facilitates free-form processing or filing of a subset of the image data.

5. The system of claim 4, further comprising an assignment component that allows an image to be queued for processing prior to being final filing.

6. The system of claim 1, the image appliance facilitates ad-hoc routing of the image data.

7. The system of claim 6, further comprising a controlled routing component that allows a image to be systematically “pushed” to a processor for processing.

8. The system of claim 1 wherein the image data is housed in a central repository and wherein the repository management component facilitates access to the image data from the central repository.

9. The system of claim 1 wherein the image data is housed in a distributed repository and wherein the repository management component facilitates access to the image data from the distributed repository.

10. The system of claim 1, further comprising an intake staging component that receives the image data from each of the plurality of input sources.

11. The system of claim 3, further comprising a case folder creation component that dynamically establishes a case folder associated with the image data, wherein the case folder management component facilitates entry of the image data into the associated case folder.

12. The system of claim 11, further comprising a case number assignment component that establishes a name for the case folder based at least in part upon content of the image document.

13. The system of claim 11, further comprising a case owner assignment component that assigns at least one processor to the case folder based at least upon content of the image document.

14. The system of claim 1, further comprising a user interface component that enables the processor to search for a particular image document or case folder based upon at least one of type, name, or content.

15. The system of claim 14, further comprising a search component that facilitates establishment of a query, wherein the query is employed to access a portion of the image data from a store.

16. The system of claim 15, further comprising a retrieval component that employs the query to access the portion of the image data from the store.

17. The system of claim 15, further comprising a modification component that enables a user to modify the portion of the image data.

18. A computer-implemented method of managing image data, comprising:
receiving a plurality of image documents;
examining the plurality of image documents;
assigning a case number to the plurality of image documents based upon the examination; and
storing the plurality of image documents into a case folder based upon the assigned case number.

19. The method of claim 18, further comprising creating the case folder based at least in part upon one of type or content of the image documents.

20. The method of claim 19, further comprising assigning the case folder to a processor.

21. A computer-executable system, comprising:
means for receiving an order for an image appliance;
means for establishing a unit-specific appliance, wherein the unit-specific appliance is based upon a standard appliance; and
means for delivering the unit-specific appliance to a business unit.

22. The computer-executable system of claim 21, wherein the unit specific appliance provides at least one of case type workflow, organization of images and electronic data for freeform processing and filing, or ad-hoc document routing.

23. The system of claim 22, further comprising an ownership component that allows for ownership of the image to be established for subsequent processing.

24. The system of claim 23, further comprising a prioritization mechanism to allow an image to be pushed based on age or Gatekeeper assigned priority.
